(19) United States
(12) Patent Application Publication
(10) Pub. No.: US 2023/0067693 A1
(43) Pub. Date: Mar. 2, 2023

(54) DEVICE AND METHOD FOR CUTTING INSULATION

(71) Applicant: Vicon Machinery, LLC, Pevely, MO (US)

(72) Inventors: Dale Foster, Barnhart, MO (US); Mike Fischer, Festus, MO (US); Jared Wells, Festus, MO (US); William Dennis, De Soto, MO (US)

(21) Appl. No.: 17/895,922

(22) Filed: Aug. 25, 2022

Related U.S. Application Data
(63) Continuation-in-part of application No. 15/950,836, filed on Apr. 11, 2018, now abandoned.
Application No. 15/950,836 is a division of application No. 14/152,239, filed on Jan. 10, 2014, now Pat. No. 9,981,399.
(60) Provisional application No. 61/751,624, filed on Jan. 11, 2013.

(51) Int. Cl. B26D 7/32; B26D 1/18; B26D 5/00; B26D 7/06

(52) U.S. Cl. CPC B26D 7/32; B26D 1/18; B26D 5/00; B26D 7/0625; Y10T 83/162; Y10T 83/0448

(57) ABSTRACT

An insulation cutter for a liner application machine in an assembly line and method of operation that cuts an insulative thermal blanket using a rotary cutter to traverse the width of the thermal insulation blanket while the insulative thermal blanket is separate from the metal ductwork. The pieces are then later brought into contact for attachment.

### CROSS REFERENCE TO RELATED APPLICATION(S)

This application is a Continuation-In-Part (CIP) of U.S. Utility patent application Ser. No. 15/590,836, filed Apr. 11, 2018, which is a Divisional of U.S. Utility patent application Ser. No. 14/152,239, filed Jan. 10, 2014, which, in turn, claims benefit of U.S. Provisional Application Ser. No. 61/751,624 filed Jan. 11, 2013. The entire disclosure of all the above references is herein incorporated by reference.

### BACKGROUND OF THE INVENTION

### 1. Field of the Invention

This disclosure is related to the field of insulation cutting machines. More specifically, the present disclosure relates to devices, methods and processes for cutting insulation such as cutting insulation for ductwork consisting of thick fiber on various types of backing including reflective aluminum backing.

### 2. Description of the Related Art

Thermal insulation is an important component in achieving thermal comfort for the occupants of building structures. Specifically, insulation reduces unwanted heat loss or gain, can decrease the energy demands of heating and cooling systems and can increase sound attenuation.

Insulation is often utilized in ductwork to increase the comfort, energy efficiency and sound attenuation of forced-air heating and cooling systems. In building structures with forced-air heating and cooling systems, ducts are used to distribute air throughout the structure. Stated differently, air ducts are the throughways through which treated air from heating or conditioning equipment in forced-air systems is distributed throughout the building structure.

Air ductwork is usually constructed out of thin metal sheets that, due to their physical construction and properties, easily conduct heat. Generally, air ducts lose heat in three main ways: first by conduction of heat through contact of the material with the surrounding air; second by radiation; and third by leaking through the cracks and seams of the air duct system. In fact, according to the United States Department of Energy, due to extreme winter and summer temperatures present in unconditioned spaces where ducts travel, about 10 to 30 percent of the energy used to heat and cool air is lost through conduction through duct surfaces.

It is well known that this energy loss in ductwork systems can be mitigated through the use of insulation—good duct insulation will improve the energy efficiency of insulated forced-air systems. When utilized, insulation has the ability to save money by increasing the efficiency of heating and cooling systems by as much as twenty (20) percent.

The insulation that is utilized for ductwork systems is generally comprised of materials used to reduce heat transfer by conduction, radiation or convection in varying combinations to achieve the desired outcome; i.e., thermal comfort with reduced energy consumption. One type of insulation commonly used in air ducts is thermal batting (batts) or blankets. This type of insulation is generally available in large, continuous rolls. Notably, compression or matting of the material which comprises the blanket impairs its functionality. Common materials utilized to create thermal blankets include, but are not limited to: rock and slag wool (usually made from rock (basalt, diabase) or iron ore); fiberglass (made from molten glass, usually with 20% to 30% recycled industrial waste and post-consumer content); high-density fiberglass; plastic fiber; polyester fiber; and elastomeric materials. Generally, thermal blankets comprised of elastomeric foam and plastic fiber have numerous beneficial thermal properties over insulation comprised of fiberglass. In addition, these types of insulation are not as abrasive as fiberglass-based thermal blankets. However, due to their high density and fibrous content, these forms of insulation are notoriously hard to cut and handle.

Often, many insulative thermal blankets further include a thermally reflective surface called a radiant barrier. This material is added to the thermal blanket to reduce the transfer of heat through radiation as well as conduction. When a radiant barrier, such as aluminum sheet or another commonly utilized reflective substance, is utilized it creates a reflective insulation product that is able to control conductive heat transfer, radiant heat transfer, and condensation all in one product.

While beneficial from a thermodynamic standpoint, this thermally reflective surface can add complexity to the cutting of the thermal blanket—it makes it harder to get a clean and precise cut. For example, new thermally beneficial insulative thermal blankets such as PolyArmor® by Ductmate (a polyester duct liner—fiberglass free—with a radiant layer backing) can be notoriously difficult to cut and manage.

Despite the fact that the use of insulation has become ubiquitous in the ductwork industry, the methodologies for cutting insulation for ductwork have remained old-school, outdated and rudimentary. A large majority of insulation is still cut manually and by hand using box cutters, utility knives, round knives and/or passive rotary blades (i.e., non-powered rotary blades or “pizza cutters”) with a guide for the respective outline of the size of insulation desired. In this conventional methodology, a worker rolls out the thermal blanket, places a cutting guide over the thermal blanket that corresponds with the desired shape of the thermal insulation to be cut, and utilizes a box cutter, passive rotary blade or other known non-powered blade mechanism to cut around the guide to cut out the desired shape from the thermal blanket. In this process, the cutting mechanism often fails to make a clean cut through the thermal blanket. Further, the radiant layer is also often improperly cut or torn in this procedure.

This conventional manual method for cutting insulation is problematic on a number of levels: it is high in cost, requires manual labor, is inefficient, ruins the product (as noted previously, it often chops the product off), and results in a very imprecise cut. In addition, as fiberglass is very abrasive, the thermal blanket can quickly wear down the blade of the cutting apparatus utilized, resulting in this equipment having to be changed often (and thus further adding to the cost of the procedure). In sum, the conventional method for manually cutting thermal blankets for rectangular air duct and fittings is a time and money waster. This is especially true now that, in many markets, thermal blanket insulation costs more than the sheet metal to which it is attached.

While some alternatives to manual insulation cutting have emerged in the market, these methodologies are still insufficient for a number of reasons. Water jet cutting, while providing precision and accuracy in cutting, still lacks the efficiency and speed required to utilize it as a cutting methodology on an automated assembly line. Further, water jet cutting still includes a manual component—the pieces, once cut, are removed from the thermal blanket by hand. This manual removal exposes the pieces to tearing, compression and other manual damage.

Another mechanized method of insulation cutting currently utilized in the art is the chop method. In this method a long knife blade is utilized in an assembly line in a guillotine-like fashion—when released it cuts the insulation blanket via a chopping methodology. Yet another newly-utilized method for cutting ductwork insulation is the swing blade method. Similar to the chop method, in this method a long knife blade is utilized on an assembly line. In this method, the serrated long knife blade is released and slices through the thermal insulation. Generally, in this method, the knife blade is affixed to two pivoting brackets that allow the knife to swing down while remaining parallel with the thermal insulation and chopping through in a swinging motion quite similar to the chopping methodology, but allowing for some side-to side cutting action.

Notably, both the chop and the swing blade methods are utilized on ductwork assembly lines. These assembly lines, as will be discussed further in this application, generally function as follows. Pieces of cut metal ductwork that correspond to particular sections of the ductwork structure to be assembled travel down a belt in the assembly line. In addition to the continuous stream of cut metal ductwork pieces, a continuous stream of thermal insulative blanket, which will be adhered to the precut metal ductwork, also travels down the assembly line. Generally, the thermal insulative blanket is adhered to the precut metal ductwork by glue or similar adhesive and nails (called pins) (or similar fastening methodology). This adhesion of the sheet metal and insulative blanket to each other generally occurs in a continuous manner.

This continuous stream of insulative blanket and precut sheet metal generally requires uninterrupted cutting of the thermal insulative blanket so that the merger and adhesion of the two pieces (sheet metal and insulation) will not be impermissibly altered. Thus, quick automated technologies, such as the chop and swing blade method, are utilized so that a cut can be accomplished without interrupting the continuous stream of component parts down the assembly line. That is, the flow is not stopped for the cutting action. Thus, the cutting action is generally very quick and is along all the points of cutting at once so that a straight, and not angled, cut is made. The problem with both of these automated technologies however is the motion is often not sufficient to cut through elastomeric thermal insulation blankets that are further comprised of a layer of radiant material because of the extra resistance it provides.

Accordingly, there is a need in the art for an insulation cutting mechanism that can be utilized in an automated production line that is able to properly cut-through all types of thermal insulation blankets (including elastomeric-based thermal blankets with a reflective layer) without damaging the insulation in the cutting process

### SUMMARY OF THE INVENTION

The following is a summary of the invention, which should provide to the reader a basic understanding of some aspects of the invention. This summary is not intended to identify critical elements of the invention or in any way to delineate the scope of the invention. The sole purpose of this summary is to present in simplified text some aspects of the invention as a prelude to the more detailed description presented below.

This disclosure provides for an insulation cutter for a liner application machine in an assembly line and method of operation that cuts an insulative thermal blanket using a rotary cutter to traverse the width of the thermal insulation blanket while the insulative thermal blanket is separate from the metal ductwork. The pieces are then later brought into contact for attachment.

There is described herein, in an embodiment, a liner application machine for attaching an insulative thermal blanket to a piece of metal ductwork, the machine comprising: a frame; a roll of insulative thermal blanket material mounted on said frame; a piece of metal ductwork carried by said frame; a gripping mechanism for removing a portion of said insulative thermal blanket material from said roll; and a cutting mechanism including a motorized rotary blade which is configured to traverse a path across said portion of said insulative thermal blanket material cutting a piece of blanket from said roll; wherein, when said piece of blanket is cut from said portion, said piece of blanket and said piece of metal ductwork are not in contact with each other; and wherein, after said piece of blanket is cut from said portion, said piece of blanket is brought into contact with said piece of metal ductwork and attached to said metal ductwork.

In an embodiment of the machine, the gripping mechanism comprises a plurality of grip rollers.

In an embodiment of the machine, the gripping mechanism comprises a grasping arm.

In an embodiment of the machine, the gripping mechanism is moveable on said frame relative to said frame.

In an embodiment of the machine, the metal ductwork moves on said frame in a downstream direction and said portion is extended by said gripping mechanism in said downstream direction.

In an embodiment of the machine, the metal ductwork moves on said frame in a downstream direction and said portion is extended by said gripping mechanism in said upstream direction.

In an embodiment of the machine, the cutting mechanism is mounted in a fixed positon on said frame.

In an embodiment of the machine, the cutting mechanism is moveable on said frame relative to said frame without said cutting mechanism cutting said insulative blanket material.

In an embodiment of the machine, the cutting mechanism cuts said piece of blanket from said roll while said piece of metal ductwork is moving on said frame relative to said frame.

In an embodiment of the machine, the cutting mechanism cuts said piece of blanket from said roll and holds said cut piece of blanket separate from said piece of metal ductwork for a period of time before said piece of blanket is brought into contact with said piece of metal ductwork.

There is also described herein, in an embodiment, a method for cutting an insulative thermal blanket during assembly of lined ductwork, the method comprising: providing a liner application machine, the machine comprising: a frame; a roll of insulative thermal blanket material mounted on said frame; a piece of metal ductwork carried by said frame; a gripping mechanism for removing a portion of said insulative thermal blanket material from said roll; and a cutting mechanism including a motorized rotary blade which is configured to traverse a path across said portion of said insulative thermal blanket material; cutting with said cutting mechanism, a piece of blanket from said portion when said piece of blanket and said piece of metal ductwork are not in contact with each other; and after said cutting, said machine moving said piece of blanket into contact with said piece of metal ductwork and attaching said piece of blanket to said metal ductwork.

In an embodiment of the method, the gripping mechanism comprises a plurality of grip rollers.

In an embodiment of the method, the gripping mechanism comprises a grasping arm.

In an embodiment of the method, the gripping mechanism is moveable on said frame relative to said frame.

In an embodiment of the method, the metal ductwork moves on said frame in a downstream direction and said portion is extended by said gripping mechanism in said downstream direction.

In an embodiment of the method, the metal ductwork moves on said frame in a downstream direction and said portion is extended by said gripping mechanism in said upstream direction.

In an embodiment of the method, the cutting mechanism is mounted in a fixed positon on said frame.

In an embodiment of the method, the cutting mechanism is moveable on said frame relative to said frame without said cutting mechanism cutting said insulative blanket material.

In an embodiment of the method, the cutting mechanism cuts said piece of blanket from said roll while said piece of metal ductwork is moving on said frame relative to said frame.

In an embodiment of the method, the cutting mechanism cuts said piece of blanket from said roll and holds said cut piece of blanket separate from said piece of metal ductwork for a period of time before said piece of blanket is brought into contact with said piece of metal ductwork.

### BRIEF DESCRIPTION OF THE DRAWINGS

FIG. 1 provides a side assembly view of a first embodiment of a liner application machine in an assembly line system.

FIG. 2A provides a front view of an embodiment of the shear assembly in which the cutting mechanism is a rotary blade.

FIG. 2B provides a side view of an embodiment of the shear assembly in which the cutting mechanism is a rotary blade

FIG. 2C provides a top view of a pressure switch.

FIG. 3 provides a front view of the cutting mechanism on its path of travel across the belt of the liner application machine.

FIG. 4 provides a side assembly view of a second embodiment of a liner application machine in an assembly line system.

FIG. 5 provides a side assembly view of a third embodiment of a liner application machine in an assembly line system.

FIG. 6 provides a side assembly view of a fourth embodiment of a liner application machine in an assembly line system.

### DETAILED DESCRIPTION OF THE PREFERRED EMBODIMENT(S)

There is described herein an insulation cutter for a liner application machine in an assembly line that cuts the insulation by stopping the liner application machine momentarily to allow for a rotary cutter to traverse the width of the belt (and the width of the thermal insulation blanket) and potentially return back to its original position. The machine is then restarted and allowed to continue to feed.

When referred to herein it should be understood that the term insulative thermal blanket, which is the product being cut by the machine, includes insulative thermal blankets with a thermally reflective surface and insulative thermal blankets without a thermally reflective surface. However, the systems and methods discussed herein are principally used when the insulative thermal blanket includes a thermally reflective surface as these pose a more difficult challenge for conventional swing-arm and chop cutting machines.

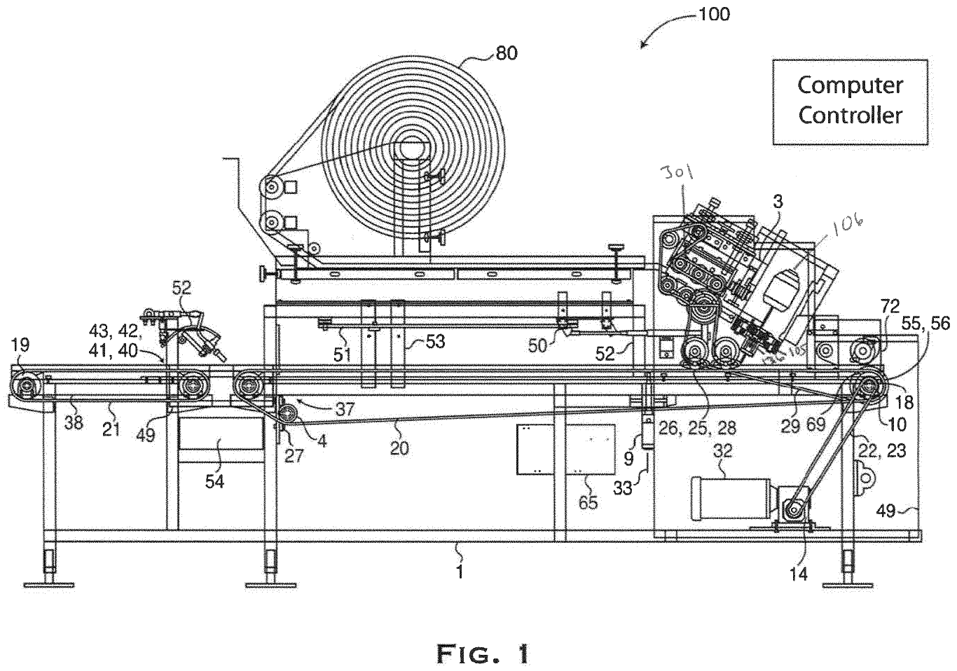

The device (100) as described herein is contemplated for use with any pinner conveyor assembly line system with a liner application machine (or other similar system known to those of ordinary skill in the art) for the production of sheet ductwork with a thermal insulation blanket attached thereto. In one embodiment, this liner application machine in the assembly line system is of generally known construction and will generally appear as depicted in FIG. 1. The device depicted in FIG. 1 includes a frame (1); an insulation cradle assembly (2); a take-up roll assembly (4); a squaring pin assembly (9); a drive shaft (conveyor pulley) (10); a leeson reducer (14); a variable pitch sheave (18); pillow block bearing (19); a belt (20 and 21); a single riveted chain (22); a chain connecting link (23); a drive tightener (25); a tightener shaft (26); pillow block bearing (27); a v-belt flat face idler pulley (28); a v-belt (29); an inverter duty motor (32); an adhesive assembly (40); a glue manifold (41); an air manifold (42); a pneumatic/adhesive schematic (43); a chain guard assembly drive (49); an adjusting sensor mount assembly insulation shear (50); a sensor mount bracket (51); sensor mount bracket glue tips and feed rolls (52); a mount strap duct liner pump (53); a drain pan (54); sprockets (55 and 56); a mount plate with air valves (65); an adjusting stop block (69); and a guard driven stilson roll shaft (72). These components are generally of conventional construction and are well understood by those of ordinary skill in the art.

The device (100) also includes a shear assembly (3). In a conventional machine, this shear assembly might comprise a chop or swing-blade mechanism, or may not be present at all. However, in the device of FIG. 1, the shear assembly (3) is designed to utilize a rotary blade cutter (106). In general, the shear assembly (3) of FIG. 1 will generally be located on the portion of the liner application machine (100) just prior to where the insulation comes into contact with the metal ductwork sheeting. Stated differently, the shear assembly (3) is generally located in a position, as depicted in FIG. 1, where the insulation is cut prior to becoming glued, nailed or otherwise attached to the ductwork metal sheeting. The shear assembly (3) of FIG. 1 also includes a series of grip rollers (301) which may be used to assist in pulling the thermally insulative blanket (80) from its roll and to provide it solidly and squarely to the rotary blade cutter (106).

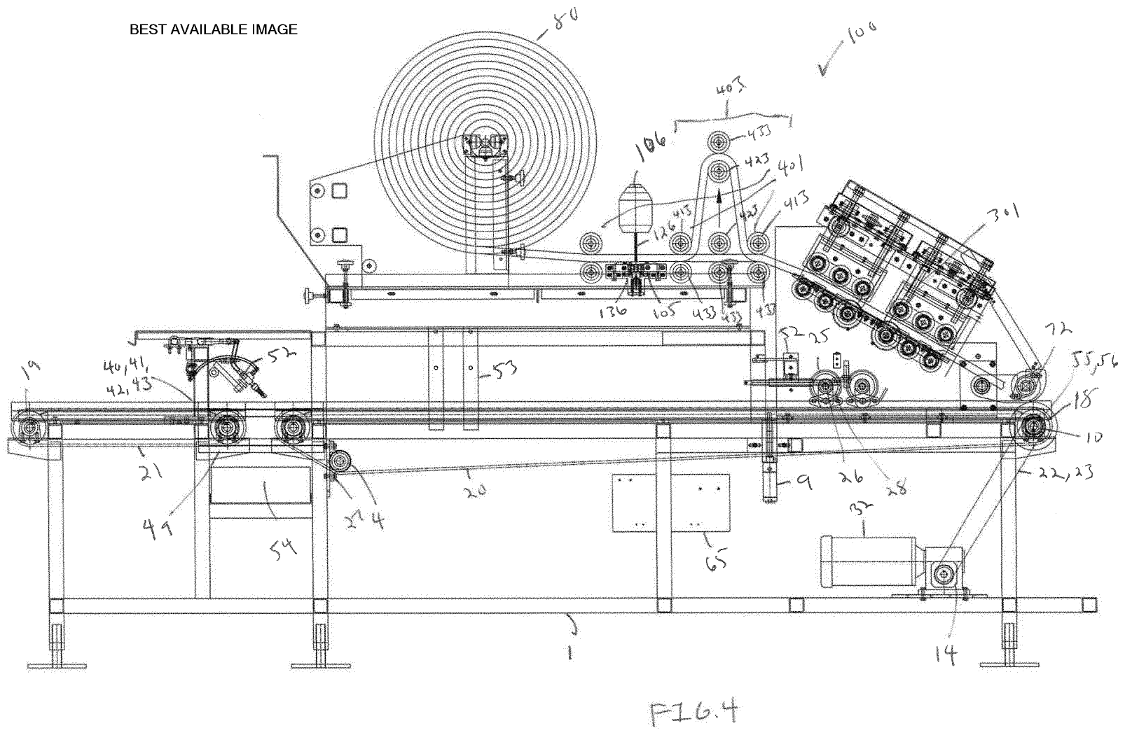

In the embodiments of FIGS. 4, 5, and 6, the rotary cutter (106) may be separated form the grip rollers (301) and any associated motors and other devices necessary or useful to operate them to interact with the thermally insulative blanket (80). This, effectively, breaks down the shear assembly (3) into multiple separate components in these embodiments. However, the same components and their same functions are generally still present in these alternative embodiments, the components have just been moved to alternative points on the device (100).

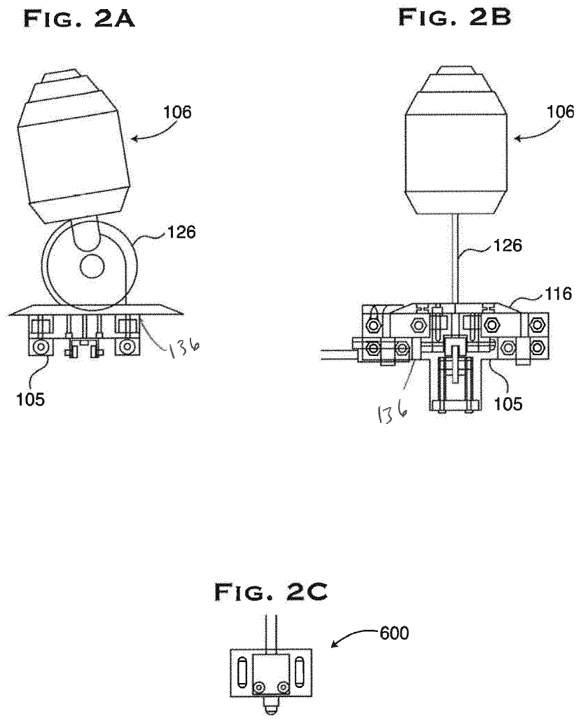

As noted previously, in one embodiment, the cutting mechanism (106) is a rotary blade (126) known to those of ordinary skill in the art for cutting fiberglass, elastomeric, plastic or other materials known to be utilized to construct thermal insulating blankets. However, any cutting mechanism that is capable of traversing the span of the conveyor belt carrying the material and adequately cutting the insulative thermal blanket is contemplated in this application. In the embodiments described herein, it is contemplated that the cutting mechanism (106) will be motor-powered with the rotary blade (126) not simply rotating due to linear traversal, but having a motor which actively turns the blade. FIG. 2A provides a front view and FIG. 2B a side view of an embodiment of the shear assembly (3) in which the cutting mechanism (106) includes a powered rotary blade (126).

The rotary blade (126) will generally be positioned either in close proximity to, or in contact with a cutting deck (136) upon which the blade rolls in order to keep it from having significant wobble. The pinching action of the rotary blade (126) and the deck (136) may also provide the cutting action. Alternatively or additionally, the cutting mechanism (106) may include a tongue (116) through which the rotary blade (126) passes at least part way. The tongue (116) may be positioned so as to always be at least partially underneath the insulative thermal blanket (80) or may lift the blanket (80) onto itself at the initiation of the cutting action. When the cutting action occurs, the tongue (116) can pass under the blanket (80) with the blade (126) being located primarily above the blanket (80) and the pinching action of the blade (126) and tongue (116) providing the cutting action.

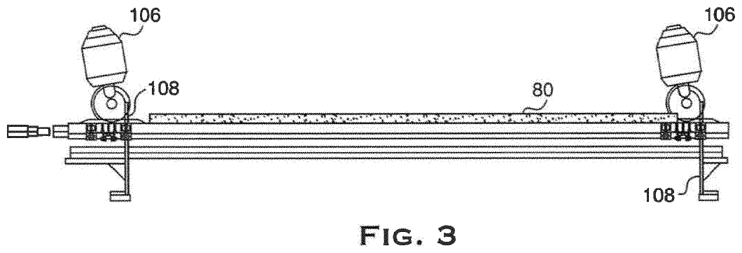

Further, FIG. 3 provides a front view of the cutting mechanism (106) on its path of travel across the belts of the liner application machine of the assembly line system. In the depicted embodiment, the path of travel of the rotary blade (106) is about 64 inches in each pass, or 128 inches per cutting event and the cutting mechanism is depicted in its two extreme or terminal positions. It should be recognized however that these distances are not determinative and that any length pass necessary to cut the insulative thermal blanket is contemplated. In one embodiment, the traversal of the cutting mechanism (106) on its path of travel across the belt as shown in FIG. 3 is powered by an air operated cable cylinder. Generally, when utilized, this air operated cable cylinder will be attached to the tracking mechanism (105) of the cutting mechanism (106) which can provide location information about the location of the cutting mechanism (105) and/or insure it is following the predefined path. It should be understood, however, that any method of powering the traversal of the cutting mechanism (106) during a cutting event known to those of ordinary skill in the art is contemplated including, but not limited to, an electric gear motor arrangement with chain and sprockets.

A cutting event of the shear assembly mechanism (3) described herein occurs when the cutting mechanism (106) completes any number of passes from its starting position on one side of the belt to the other side of the belt and/or back again. Thus a single cutting event may occur when the cutting mechanism makes a pass from its starting position on one side of the belt to the other side of the belt and back again to its original position—i.e., an “around-the-world” trip from one side of the belt to the opposite side and back again, a single pass from the starting position to the other side, a single pass from the other side back to the starting position, or any combination of these. Generally, it is contemplated that this cutting event, whether in the embodiment where it comprises a single pass or a multiple number of passes, will occur at a fast pace (i.e., in a matter of seconds).

In certain embodiments, it is contemplated that the cutting event will be controlled by computer operated software for automating such systems as known to those of ordinary skill in the art. In other embodiments, it is contemplated that the cutting event will be controlled manually, through an operator triggering a cutting event through a switch or other activation methodology known to those of ordinary skill in the art. Generally, it is contemplated that a cutting event will occur in an automated manner such that the thermal insulative blanket is cut at a point in time on the liner application machine of the assembly line such that the insulative layer will be cut in time to come into contact and be adhered to the corresponding piece of ductwork on the assembly line whose dimensions it is cut to match.

In addition to the cutting mechanism (106), it is contemplated that, in certain embodiments, the shear assembly (3) also comprises a moveable tracking mechanism (105) known to those of ordinary skill in the art. Generally any tracking mechanism (105) that is capable of moving the cutting mechanism (106) from one side of the liner application machine to the other side of the liner application machine is contemplated in this application. As seen in FIG. 3, in one embodiment, a stopping mechanism (108) or baton or other shock absorbing mechanism known to those of ordinary skill in the art will be located at each end of the path of the cutting mechanism (106). This stopping mechanism (108) will act to signal a terminating end of the cutting path of the cutting mechanism (106) during a cutting event.

In another embodiment, as seen in FIG. 3, a switch (600) or other trigger or sensor mechanism known to those of ordinary skill in the art will be located at each end of the path of the cutting mechanism (106). This switch (600) will act to signal a terminating end of the cutting path of the cutting mechanism (106) during a cutting event. One embodiment of a pressure switch (600) is shown in FIG. 2C and it may be positioned so as to contact any part of the cutting mechanism (106) when the cutting mechanism is at the extreme positions of FIG. 3. While, a pressure switch is a simple and robust system which can be used to detect when the cutting mechanism (106) is at the extremes of position, alternative switches, sensors, and detectors, may be used in alternative embodiments as would be understood by one of ordinary skill in the art.

Notably, it is contemplated that the liner application machine in the embodiment of FIG. 1 will stop momentarily during a cutting event. Generally, the stoppage of the liner application machine will be only long enough for a complete traversal of the cutting mechanism (106)—one complete “cutting event”—to occur. This stopping of the liner application machine is antithetical to the prevailing status quo in the art. First, it used to be impossible to stop the liner application machine of the assembly line during production. Second, generally, to one of ordinary skill in the art, it would not have been logical to stop a liner application machine to allow a cutting event to occur as this could slow down and otherwise falter the assembly process.

In the embodiments of FIGS. 4, 5, and 6, the liner application machine can utilize the rotary cutter to cut the insulative thermal blanket at a time when the insulative thermal blanket is in a stopped position, but the motion of the sheet ductwork is not necessarily stopped. In these embodiments, the insulative thermal blanket is “precut” to the appropriate size of the next piece of sheet ductwork and held in an idling position, or the cut of the insulative thermal blanket is timed so that it falls after being cut into correct alignment with the associated sheet ductwork piece. These embodiments can, thus, obtain the benefits of a rotary cutting mechanism (106), which requires that the insulative thermal blanket not be moving to provide a straight cut, while simultaneously not stopping the sheet ductwork flow which can improve speed of production.

In practice, it is contemplated that the shear assembly (3) mechanism disclosed herein will operate as follows in conjunction with the machine of FIG. 1. First, a roll of insulative thermal blanket (80), such as those known to those of ordinary skill in the art, will be placed on the liner application machine (100) and will travel down a liner application machine (100) of an assembly line known to those of ordinary skill in the art through the action of drive rollers or related systems. A piece of metal ductwork, to which the a piece of insulative thermal blanket (80) is to be attached, will also enter the machine (100) and be moved by drive rollers or similar systems.

As noted previously, the shear assembly (3) in the embodiment of FIG. 1 will generally be located on the liner application machine (100) of the assembly line at a location after the drive rollers but before the insulative thermal blanket (80) is connected to the metal ductwork. Thus, the two pieces may be separate at the time and location of cutting. Downstream of that point, the two elements may be separate, or may have already been attached. At a time to be determined by the operator of the assembly line (either through operating software or manually triggered by an operator), a cutting event will occur to cut the insulative thermal blanket (80) to the desired dimensions. As each resultant piece of thermally insulated ductwork is typically of specific, and therefore variable, size, the choice of when to cut is typically dictated by the specific size of each specific piece of thermal blanket being generated, which is, in turn, based on the size of the piece of sheet ductwork to which it is to be attached. The cutting event serves, specifically, to cut the desired piece of thermally insulative blanket for a selected ductwork element to be cut off the roll. When a cutting event is triggered, generally by the end of a piece of the metal ductwork to which the insulative thermal blanket (80) is to be attached will be at a specific point which may be detectable by the device (100) and the detection of which may trigger the cutting event.

Upon the cutting event being triggered, the liner application machine (100) stops. Specifically, at least the insulative thermal blanket (80) feed is halted. However, in other contemplated embodiments, both the ductwork and insulative thermal blanket (80) feeds are simultaneously stopped such as by halting the motion of all the drive rollers. It should be apparent that this may be accomplished by cutting power to the machine, or by simply stopping a universal motor which is turning both drive rollers via a common driveshaft among other options.

After the motion of the insulative thermal blanket (80) is halted, the cutting mechanism (106) will traverse one length of the belt to the point where it comes into contact with the stopping mechanism (108) (e.g. switch (600) or other device depending on the embodiment) located on the side of the belt opposite the starting point of the cutting mechanism (106). At this time in the cutting event, the cutting mechanism (106) will have travelled through the insulative thermal blanket (80) in one pass, cutting the insulative thermal blanket (80) at the stopped location. After the cut is complete, the insulation cutting machine (100) may then reactivate the stopped drive rollers and continue the process of applying and nailing (pinning) the insulation (80) to the mating sheet.

Alternatively, the cutting mechanism (106), after coming into contact with the stopping mechanism (108) on the opposite side of the belt from the starting point, re-traverses the original path, returning to the opposite side of the belt and stopping when it comes into contact with a second stopping mechanism (108) or switch (600) (depending on the embodiment) located at its original starting location. In other words, the cutting mechanism (106) crosses the belt and returns to its home location (a full circuit), in the single cutting event. In some embodiments it is contemplated that in this second pass, the cutting mechanism (106) again travels through the same cutting line the cutting mechanism (106) created in the original pass.

Thus, in certain contemplated embodiments, in this second pass the cutting mechanism (106) is able to cut any remaining fibers or other material components of the insulative thermal blanket (80) that might still be connected to each other, thus creating a clear, unobstructed cut along the entire width of the insulative thermal blanket (80). In other embodiments, this second pass does not constitute a cutting event and only serves the function of returning the cutting mechanism to its original starting location for the next cutting event. Still further, the second pass may comprise either of these events based on how well the cut was made and for certain cuts within a roll of insulative thermal blanket (80) the second pass may sometimes further cut and other times simply return the cutting mechanism (106) to its starting point. In certain embodiments, it is contemplated that this complete process should only take a matter of seconds.

It should be understood that, while cutting events comprised of only one traverse or two or more traverses of the belt (or one round-trip traverse) are described in detail in this application, any number of passes that are deemed necessary by the assembly line operator to create a clean and precise cut are contemplated as constituting a programmable and contemplated “cutting event.” For example, a “cutting event” can constitute a single traverse or any multiple number of traverses.

Regardless of how many passes are made, once the cutting event is deemed complete, the completion may be detected by operating software or the operator and the stopped feeds (insulative thermal blanket (80) and/or insulative thermal blanket and ductwork) are simultaneously restarted. The completion of a cutting event may occur either because a fixed number of passes has been completed regardless of the effectiveness of the cutting event, or a sensor or other device may be used that determines that the insulative thermal blanket (80) is sufficiently cut to allow the process to continue. It is important to note that in a preferred embodiment of FIGS. 1, during a cutting event, the liner application machine and nailer are temporarily halted. This “stutter” in the line will generally result in minimal delay and maintaining the correct assembly pattern for all pieces of ductwork in the assembly line. In effect, the precision and completeness of the cut made can provide a greater benefit than the loss of time from having to “stutter” the assembly line.

In the embodiments of FIGS. 4, 5, and 6, the liner application machine and nailer may be temporarily halted in the same way as in FIG. 1. Alternatively, the liner application machine and nailer may be allowed to continue in essentially continuous fashion. In this latter arrangement, more precise timing may be required as time to complete the act of cutting the insulative thermal blanket (80) needs to be factored into the time that it takes for the sheet ductwork to reach the position to be aligned with the resultant cut piece of insulative thermal blanket.

The embodiments of FIGS. 4, 5, and 6 generally operate in a similar fashion to that of FIG. 1. However, the positioning and presentation of the thermally insulative blanket (80) to the blade (126) of the cutter (106) is generally performed differently. This alternative presentation provides for two alterations to the methodology when compared to the operation of FIG. 1. The first change is that the thermally insulative blanket piece which is to be used is typically completely cut from the roll (80) prior to the cut thermally insulative blanket piece contacting the sheet ductwork at all. The second change is that the cut thermally insulative blanket piece may be idled after being cut for any desired length of time. When this application refers to the cut blanket piece being “idled” it is to indicate that the piece may be cut at any time prior to, or even with (zero time prior), it being moved to place it into contact with the sheet ductwork.

As should be apparent from an examination of FIG. 1, that downstream (to the right of FIG. 1) of the shear assembly (3) the sheet ductwork and thermally insulative blanket (80) may already be bonded together by the nailer and/or by contact (and typically applied pressure) between the thermally insulative blanket (80) to the adhesive provided on the surface of the sheet ductwork by the gluing assembly (52). Thus, in the embodiment of FIG. 1, a piece of insulated ductwork being manufactured may be partially assembled (the thermally insulative blanket (80) will have been attached to the sheet ductwork) prior to the thermally insulative blanket roll (80) being cut even though the two pieces may be separate at the point in space where the cutting occurs. This is by no means required by the embodiment of FIG. 1, but this partial assembly prior to cutting is possible in the embodiment of FIG. 1. In the embodiments of FIGS. 4, 5, and 6, this is typically not the case.

With regards to the embodiments of FIGS. 4, 5, and 6, the operation begins similarly to the operation of FIG. 1 with a roll of insulative thermal blanket (80), such as those known to those of ordinary skill in the art, being placed on the liner application machine (100). A piece of metal ductwork, to which the a piece of insulative thermal blanket (80) is to be attached, will also enter the machine (100) and be moved by drive rollers or similar systems from the left to the right (downstream) in the relevant FIG.

In the embodiment of FIG. 4, the thermally insulative blanket (80) is unwound from the roll by the grip rollers (301) which may also be assisted by the size selection rollers (401). In order to cut the selected piece to the correct size, it may be necessary to increase distance that the thermally insulative blanket (80) will run prior to exiting the downstream side of the grip rollers (301). This is accomplished through the use of a take-up roller assembly (403) which may be a part of the size selection rollers (401). The take-up roller assembly will generally comprise two directional rollers (413) and a moveable adjustment roller (423) each of which includes an associated pinch roller (433) to keep the material held.

In the event that a shorter piece of thermally insulative blanket material (80) is needed, the adjustment roller (423) and associated pinch roller (433) will be positioned at the lower positon shown in FIG. 4 so that the thermally insulative blanket (80) will generally pass linearly through the path of the first directional roller (413) through the adjustment roller (423) and through the second directional roller (413). Should a larger piece be needed, the adjustment roller (423) (and associated pinch roller (433)) will be moved upward as illustrated by the arrow in FIG. 4 to the higher position illustrated in FIG. 4 and the thermally insulative blanket (80) will generally pass through the first directional roller (413) but then be directed sharply upward to go to the adjustment roller (423) and then similarly sharply downward to go to the second directional roller (413). It should be recognized that the higher position of the adjustment roller (423) need not be a fixed position, but may be variable with the roller (423) being positionable at any desired or expected height above the lower position only within the constraints of the structure of the portion of the frame (1) supporting it.

In FIG. 4, the cutting event is triggered when the length of the thermally insulative blanket (80) positioned between it's downstream end (which will typically be around the downstream end of the grip rollers (301)) and the cutter (106) is of the desired length. At this time, the various rollers (401) and (301) will stop moving the insulative blanket (80) and the cutting operation may be carried out in any manner as discussed in conjunction with FIG. 1.

It should be apparent from the above description that the movement of the thermally insulative blanket (80) is at all times in the above scenario separate form the movement of the sheet ductwork which would be coming from left to right generally along the line from element (19) to element (18) in FIG. 4. This allows for the piece of thermally insulative blanket (80) to be fully and completely cut prior to it ever being fed downstream of the grip rollers (301) and into contact with the sheet ductwork to which it is to be attached. Should the cutting operation of the thermally insulative blanket material (80) occur faster than the sheet ductwork can be provided to the machine (100), this means that the each piece of blanket may be idled after cutting to allow the piece of blanket to be correctly aligned with approaching pieces of sheet ductwork which may be handled and directed by roller and grip systems which operate completely differently to the various rollers (301) and/or (401).

It should be noted that if the sheet ductwork pieces can be provided with sufficient speed to the machine (100) and the timing of the movement of the various pieces can be precisely enough known, it is possible that the various pieces of blanket are not idled at all, but are essentially immediately sent for connection with the associated piece of sheet ductwork immediately after being cut. In a still further embodiment, it is even possible that the sheet ductwork pieces would need to be idled to wait the cutting operation of the blade (106) to occur. Still further, any combination of the above timing scenarios could be performed in rapid combination as a complete set of insulated ductwork is formed by the machine using the computer controller to correctly time all the pieces of both blanket and ductwork as the blanket roll (80) is cut and the pieces are assembled

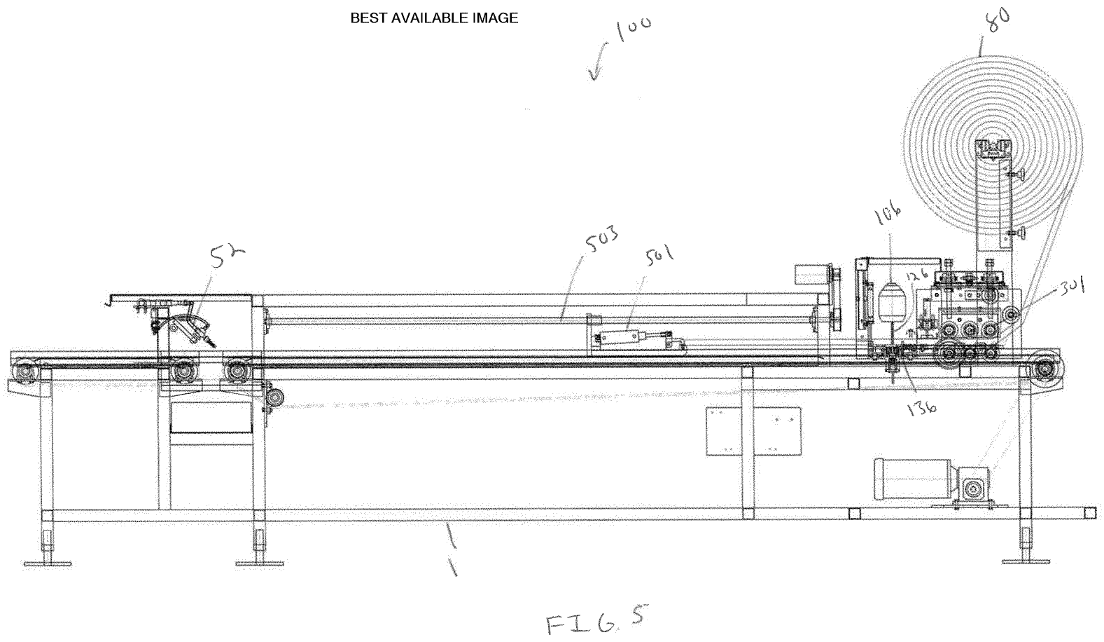

In the embodiment of FIG. 5, idling of the thermally insulative blanket (80) piece is also available. However, in this embodiment, the elements of the cutter (106) and the grip rollers (301) are altered to eliminate the need for the size selection rollers (401) although they may still be used to adjust the length of the piece of blanket should particularly long pieces (e.g. longer than the frame (1)) be required. In the embodiment of FIG. 5, the grip rollers (301) are positioned so as to direct the thermally insulative blanket (80) as it is unrolled from the roll in an upstream direction relative to the movement of the sheet ductwork. Further, to draw the thermally insulative blanket (80) from the roll a grasping arm (501) is used. The grasping arm (501) may be of any type but is designed to grasp the free end of the thermally insulative blanket roll (80). The grasping arm (501), then moves upstream via a slide rail (503) which is mounted to the frame (1). Once the desired length of the thermally insulative blanket (80) is between the grasping arm (501) and the blade (106), the unrolling will typically be halted and the blade (106) may proceed to cut the thermally insulative blanket (80) in any manner as contemplated for the embodiment of FIGS. 1 and 4.

It should be apparent from FIG. 5, that in this embodiment, the thermally insulative blanket (80) moves in the opposite direction to that of the sheet ductwork and both items may be moving in such opposing directions simultaneously. To idle the thermally insulative blanket (80) piece, the piece may be supported by a platform or other structure (not shown) which serves to hold the cut piece above the moving sheet ductwork until the piece of sheet ductwork to which it is to be attached is correctly positioned. This can potentially improve accuracy of piece connection. The cut piece of blanket may then be dropped onto the sheet ductwork. It should be recognized that while the embodiment of FIG. 5 has the thermally insulative blanket (80) unrolling in the upstream direction, this is by no means required and it could unroll in the downstream direction in an alternative. However, the upstream direction may be beneficial to assist in alignment of the resultant downstream end of the piece of thermally insulated blanket and the downstream end of the sheet ductwork.

In an alternative operation of FIG. 5, the thermally insulative blanket (80) piece may be idled prior to actually being cut or completely cut and eliminate the need for a platform or other support for the piece of blanket. Specifically, the piece of thermally insulative blanket may be supported by tension imposed on the two ends. The free (upstream) end may be held by the grasping arm (501) while the uncut end is effectively supported by the cutting deck (136) and tension from the roll (80). This can serve to freely suspend the portion of the thermally insulative blanket (80) which will be cut into the piece of blanket over the space where the sheet ductwork to which that piece of blanket is to be attached will be positioned. The thermally insulative blanket (80) may then be cut as the sheet ductwork piece passes under it into the correct positon in such a manner that the cut end (the end just cut by cutter (106)) falls into place on the temporarily held (or still moving depending on embodiment) piece of sheet ductwork underneath it. The grasping arm (501) may release it's free end in a coordinated fashion allowing the suspended piece of thermally insulative ductwork to fall onto the sheet ductwork under the influence of gravity. Other positioning systems may additionally or alternatively be employed to act to drop the piece of thermally insulative blanket (80) into place accurately including mechanical movers, air pressure systems, or other devices, systems, methods, or means known to those of ordinary skill in the art.

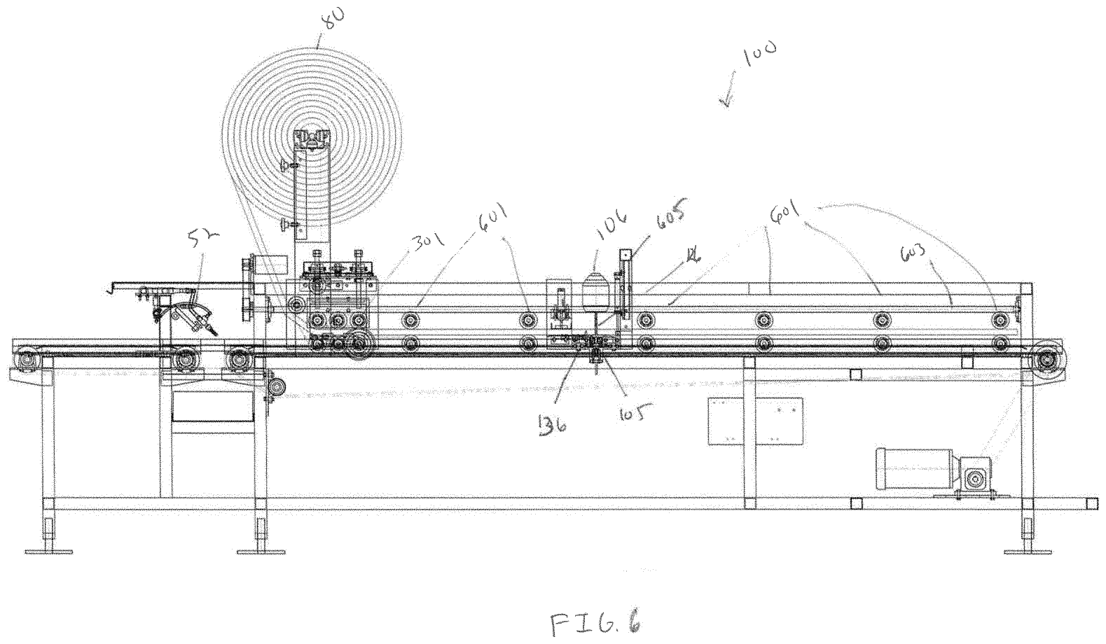

The embodiment of FIG. 6 provides for a similar embodiment to that of FIG. 5. However, instead of utilizing a gripper arm (501) to extend the blanket material from the roll (80) a further series of additional grip rollers (601) are used. Further, in this embodiment the cutter (106) is provided on a moveable carriage (605) which can traverse on a rail (603) of similar design to rail (503) of FIG. 5. In this embodiment, it is therefore not necessary for the grip rollers (601) to be used to select the size of the cut piece of the thermally insulative blanket (80). Instead, the grip rollers (601) may be used to simply pull out a known length and the carriage (605) may be positioned to cut the piece to the desired size.

It should be apparent that in FIG. 6, idling of the cut piece of thermally insulative blanket (80) may be performed using any of the systems, methods, and means contemplated above in conjunction with FIG. 5 as the resultant piece of thermally insulative blanket (80) will generally be positioned in a similar fashion onto the associated piece of sheet ductwork. Similarly, cutting of the thermally insulative blanket (80) material may be performed by any manner contemplated previously.

The embodiment of FIG. 6 illustrates an arrangement where the roll (80) is unwound downstream, but as with FIG. 5, this choice is somewhat arbitrary and the roll (80) may be unwound upstream. However, as is discussed in conjunction with FIG. 5 selection of a downstream unrolling may be desirable to assist with alignment of the downstream ends of the thermally insulative blanket (80) and the sheet ductwork.

As indicated in the various embodiments above, the shear assembly (3) disclosed herein, whether it is provided as the assembly of FIG. 1 or disassembled with the pieces being used in alternative arrangements as contemplated by FIGS. 4, 5, and 6 is an advance over the other thermal insulative blanket cutting systems utilized in the art because it is automated, precise, can be used in a liner application machine (100) in an assembly line and, importantly, can adequately and completely cut through newer elastomeric insulative thermal blanket products with a radiant layer such as PolyArmor®, which products could not be adequately cut by the cutting mechanisms of the prior art.

While the invention has been disclosed in conjunction with a description of certain embodiments, including those that are currently believed to be useful embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

It will further be understood that any of the ranges, values, properties, or characteristics given for any single component of the present disclosure can be used interchangeably with any ranges, values, properties, or characteristics given for any of the other components of the disclosure, where compatible, to form an embodiment having defined values for each of the components, as given herein throughout. Further, ranges provided for a genus or a category can also be applied to species within the genus or members of the category unless otherwise noted.

The qualifier “generally,” and similar qualifiers as used in the present case, would be understood by one of ordinary skill in the art to accommodate recognizable attempts to conform a device to the qualified term, which may nevertheless fall short of doing so. This is because terms such as “spherical” are purely geometric constructs and no real-world component or relationship is truly “spherical” in the geometric sense. Variations from geometric and mathematical descriptions are unavoidable due to, among other things, manufacturing tolerances resulting in shape variations, defects and imperfections, non-uniform thermal expansion, and natural wear. Moreover, there exists for every object a level of magnification at which geometric and mathematical descriptors fail due to the nature of matter. One of ordinary skill would thus understand the term “generally” and relationships contemplated herein regardless of the inclusion of such qualifiers to include a range of variations from the literal geometric meaning of the term in view of these and other considerations.

1. A liner application machine for attaching an insulative thermal blanket to a piece of metal ductwork, the machine comprising:
a frame;
a roll of insulative thermal blanket material mounted on said frame;
a piece of metal ductwork carried by said frame;
a gripping mechanism for removing a portion of said insulative thermal blanket material from said roll; and
a cutting mechanism including a motorized rotary blade which is configured to traverse a path across said portion of said insulative thermal blanket material cutting a piece of blanket from said roll;
wherein, when said piece of blanket is cut from said portion, said piece of blanket and said piece of metal ductwork are not in contact with each other; and
wherein, after said piece of blanket is cut from said portion, said piece of blanket is brought into contact with said piece of metal ductwork and attached to said metal ductwork.

2. The machine of claim 1, wherein said gripping mechanism comprises a plurality of grip rollers.

3. The machine of claim 1, wherein said gripping mechanism comprises a grasping arm.

4. The machine of claim 1, wherein said gripping mechanism is moveable on said frame relative to said frame.

5. The machine of claim 1, wherein said metal ductwork moves on said frame in a downstream direction and said portion is extended by said gripping mechanism in said downstream direction.

6. The machine of claim 1, wherein said metal ductwork moves on said frame in a downstream direction and said portion is extended by said gripping mechanism in said upstream direction.

7. The machine of claim 1, wherein said cutting mechanism is mounted in a fixed positon on said frame.

8. The machine of claim 1, wherein said cutting mechanism is moveable on said frame relative to said frame without said cutting mechanism cutting said insulative blanket material.

9. The machine of claim 1, wherein said cutting mechanism cuts said piece of blanket from said roll while said piece of metal ductwork is moving on said frame relative to said frame.

10. The machine of claim 1, wherein said cutting mechanism cuts said piece of blanket from said roll and holds said cut piece of blanket separate from said piece of metal ductwork for a period of time before said piece of blanket is brought into contact with said piece of metal ductwork.

11. A method for cutting an insulative thermal blanket during assembly of lined ductwork, the method comprising:
providing a liner application machine, the machine comprising:
a frame;
a roll of insulative thermal blanket material mounted on said frame;
a piece of metal ductwork carried by said frame;
a gripping mechanism for removing a portion of said insulative thermal blanket material from said roll; and
a cutting mechanism including a motorized rotary blade which is configured to traverse a path across said portion of said insulative thermal blanket material;
cutting with said cutting mechanism, a piece of blanket from said portion when said piece of blanket and said piece of metal ductwork are not in contact with each other; and
after said cutting, said machine moving said piece of blanket into contact with said piece of metal ductwork and attaching said piece of blanket to said metal ductwork.

12. The method of claim 11, wherein said gripping mechanism comprises a plurality of grip rollers.

13. The method of claim 11, wherein said gripping mechanism comprises a grasping arm.

14. The method of claim 11, wherein said gripping mechanism is moveable on said frame relative to said frame.

15. The method of claim 11, wherein said metal ductwork moves on said frame in a downstream direction and said portion is extended by said gripping mechanism in said downstream direction.

16. The method of claim 11, wherein said metal ductwork moves on said frame in a downstream direction and said portion is extended by said gripping mechanism in said upstream direction.

17. The method of claim 11, wherein said cutting mechanism is mounted in a fixed positon on said frame.

18. The method of claim 11, wherein said cutting mechanism is moveable on said frame relative to said frame without said cutting mechanism cutting said insulative blanket material.

19. The method of claim 11, wherein said cutting mechanism cuts said piece of blanket from said roll while said piece of metal ductwork is moving on said frame relative to said frame.

20. The method of claim 11, wherein said cutting mechanism cuts said piece of blanket from said roll and holds said cut piece of blanket separate from said piece of metal ductwork for a period of time before said piece of blanket is brought into contact with said piece of metal ductwork.
